(19) United States
(12) Patent Application Publication
(10) Pub. No.: US 2013/0173480 A1
(43) Pub. Date: Jul. 4, 2013

(54) MAINTENANCE CYCLE FOR AN AIRCRAFT

(71) Applicants: Manfred Paul, Nackenheim (DE); Oliver Bertram, Frankfurt (DE)

(72) Inventors: Manfred Paul, Nackenheim (DE); Oliver Bertram, Frankfurt (DE)

(21) Appl. No.: 13/690,674

(22) Filed: Nov. 30, 2012

(30) Foreign Application Priority Data
Nov. 30, 2011 (DE) 102011087423.2

(51) Int. Cl. G06Q 10/00

(52) U.S. Cl. CPC G06Q 10/20
USPC 705/305

(57) ABSTRACT

The invention relates to a maintenance cycle for an aircraft, which comprises the steps a) carrying out a maintenance process for an aircraft after the expiry of a time interval (ΔT) which is less than or equal to a specified maintenance interval (ΔT_{W}); b) collecting findings data for at least one maintenance measure during the maintenance process; c) archiving the findings data from step b) and the time interval ΔT; d) determining at least one classification number using automated statistical evaluation of archived findings data for all maintenance processes occurring within a first observation period and/or using the averaged utilization factor (G) of the maintenance interval for a second observation period, wherein the first observation period and the second observation period can be the same or different and e) producing an action request for checking and/or adaptation of the maintenance interval as long as the at least one classification number from step d) lies outside a specified tolerance range. The invention also relates to a method for assessing and/or monitoring of a maintenance program for aircraft, a method for the comparison of at least two maintenance programs for aircraft, an apparatus for checking and/or adaptation of a maintenance interval for an aircraft and a signal sequence.

The invention is in the technical field of maintenance of aircraft and relates to a maintenance cycle for an aircraft and an apparatus for the checking and/or adaptation of a maintenance interval for an aircraft. The invention also relates to a method of assessing and/or monitoring of a maintenance program for aircraft, a method for the comparison of at least two maintenance programs for aircraft and a signal sequence representing data for writing to and/or reading from a working memory and/or for sending over the Internet, wherein the data represent a statistical evaluation program for running on a computer system as part of an apparatus for checking and/or adaptation of a maintenance interval for an aircraft.

Aircraft must be maintained regularly in order to ensure reliable operation. Suitable maintenance programs provide the implementation of maintenance processes in maintenance intervals. On the one hand the respective maintenance interval must be selected so that the technical safety and reliability of the aircraft is guaranteed. Appropriate aviation legal requirements, such as for permissible defect rates, are to be observed here. This means that the maintenance interval may not be so long that the permissible defect rate is exceeded. On the other hand the length of the maintenance interval should also satisfy economic requirements, i.e. unnecessarily frequent maintenance of the aircraft should be avoided. The technical and economic optimization of maintenance intervals is therefore of special importance for a maintenance program for aircraft. Previous optimization approaches are expensive and labor-intensive.

US 2010/0070237 A1 discloses a method for checking or adaptation of maintenance intervals, with which there is balancing of the frequencies of planned maintenance processes on the one hand and unplanned maintenance processes (malfunctions) on the other hand. This is especially costly, however, because structured data acquisition is frequently not possible or is only possible with difficulty in the event of malfunctions or unplanned maintenance processes during operation.

Against this background the general object of the invention is to enable simple checking and where appropriate adaptation of the maintenance interval for aircraft.

This object is achieved through the subject of the independent claims. Advantageous embodiments are to be found in the dependent claims.

The invention has recognized that simple checking and where appropriate adaptation of the maintenance interval is enabled by means of an automated statistical evaluation of archived findings data, and in addition a basis is provided for the assessment and/or monitoring of a maintenance program or the comparison of maintenance programs.

Some terms used in the context of the invention are first explained.

The term aircraft refers to vehicles that travel in the air, in particular airplanes. The maintenance of an aircraft takes place in the context of maintenance cycles, wherein maintenance processes take place depending on maintenance intervals.

A maintenance interval (ΔT_{W}) is understood to be the planned time interval between two maintenance processes. The respective maintenance intervals can vary depending on the type of maintenance process. Thus it can occur e.g. that some maintenance processes take place weekly, others monthly or annually and again others occur depending on a certain number of flying hours. It can happen that a maintenance interval is not fully utilized, i.e. the actual time interval (ΔT) between two maintenance processes can be less than or equal to the specified maintenance interval (ΔT_{W}). The degree of agreement between the time interval (ΔT) and the maintenance interval (ΔT_{W}) is termed in the context of the invention as the utilization factor of the maintenance interval. Preferably, the utilization factor of the maintenance interval is a function of the quotient of the time interval and the maintenance interval (ΔT/ΔT_{W}). Advantageously, the time interval (ΔT) and/or the maintenance interval (ΔT_{W}) are calculated in days, preferably in flying cycles, especially preferably in flying hours. However, it can also be provided that the time interval (ΔT) and/or the maintenance interval (ΔT_{W}) are calculated multidimensionally, e.g. both in flying hours and also in days. In this case a maintenance process is provided following a certain number of flying hours or a certain number of days, depending on which limit is reached first.

A maintenance process comprises at least one maintenance measure for a system or a component of the aircraft. One or a plurality of maintenance measures can thus occur during the course of a maintenance process. A maintenance process can also essentially include the maintenance of the entire aircraft, e.g. in the context of a major overhaul. It is possible that measures are taken to preserve or reproduce a certain desired state during the course of a maintenance measure. However, within the scope of the invention the term maintenance measure also includes the simple inspection, whereby only one finding is produced. Within the scope of the invention planned maintenance processes are preferably carried out in a standard manner and independently of whether there is a malfunction. One aspect of the invention is based on the knowledge that from the evaluation of the findings data only said planned maintenance processes can provide evidence for a possible adaptation of maintenance intervals according to the invention.

Results data for at least one maintenance measure are collected during a maintenance process. The collected findings data can be quantitative findings data, which can be measured on a metric scale. Examples of this are the degree of wear of a component or the degree of fouling of a component. The findings data can, however, also be of a qualitative nature, i.e. they include certain states or categories, e.g. the two states “defective” or “not defective”.

Positive findings are findings that detect a fault and negative findings are findings that do not detect a fault. The criteria for the presence of a fault are specified for each maintenance measure.

A maintenance cycle according to the invention comprises the following steps:
a. Carrying out a maintenance process for an aircraft after the expiry of a time interval (ΔT) which is less than or equal to a specified maintenance interval (ΔT_{W});
b. Collecting findings data for at least one maintenance measure during the maintenance process;
c. Archiving the findings data from step b) and the time interval ΔT;
d. Determining at least one classification number using the automated statistical evaluation of archived findings data for all maintenance processes occurring within a first observation period and/or using the averaged utilization factor (G) of the maintenance interval for a second observation period, wherein the first observation period and the second observation period can be the same or different;
e. Producing an action request for the checking and/or adaptation of the maintenance interval, as long as the at least one classification number from step d) lies outside a specified tolerance range.

It is advantageous if the archived findings data used for the statistical evaluation originate from more than one aircraft. For example, the findings data can originate from a plurality of comparable aircraft of a fleet. In this way a sufficiently large quantity of data for the statistical evaluation can be accumulated relatively quickly.

According to the invention, during the maintenance cycle at least one classification number is determined using an automated statistical evaluation of archived findings data for all maintenance processes occurring within a first observation period and/or using the averaged utilization factor (G) of the maintenance interval for a second observation period, wherein the first observation period and the second observation period can be the same or different. The statistical evaluation is automated, i.e. it does not take place entirely manually, but essentially with the aid of a data processing system. The statistical evaluation of the findings data takes place at the level of the maintenance measure.

Preferably, the averaged utilization factor (G) of the maintenance interval is calculated from the average of all utilization factors within the second observation period.

Advantageously, in step d) of the maintenance cycle at least one classification number QF1 is formed using the averaged utilization factor (G) of the maintenance interval for the second observation period, wherein a threshold value (S) is specified, wherein QF1 is formed as follows:

for S≦G: QF1=1.0;

for G<S: QF1=G*(1.0/S);

and wherein preferably 0.5≦S≦0.95, more preferably 0.75≦S≦0.95 and particularly preferably S=0.9.

Within the scope of the invention it is preferable that the length of the first observation period and/or the length of the second observation period can be represented in whole quarters and/or that the length of the first observation period and/or the length of the second observation period is determined depending on the maintenance interval (ΔT_{W}). Advantageously, the length of the first observation period and/or the second observation period is at least one quarter, preferably at least four quarters, more preferably at least eight quarters. It is particularly preferable that the first observation period is longer than the second observation period, wherein preferably the first observation period is four quarters and the second observation period is one quarter.

Advantageously, the length of the first observation period and/or the length of the second observation period can be determined in whole quarters as follows:

Number of quarters=ΔT_{W} (days)/90 days;

wherein where appropriate this is rounded to the next higher number of quarters and wherein the number of quarters is preferably at least 4.

Advantageously, in step d) of the maintenance cycle at least one classification number is formed using an automated statistical evaluation of archived findings data for all maintenance processes occurring within a first observation period, wherein the at least one classification number is a function of the number of positive findings for the first observation period, preferably a function of the probability of a positive finding per flying hour.

For quantitative findings data it is possible to determine one or a plurality of classification numbers by means of regression analysis. It can therefore be provided that in step d) at least one classification number is determined using an automated regression analysis of archived quantitative findings data, which can be measured on a metric scale, for all maintenance processes occurring within a first observation period.

Preferably least 5%, more preferably at least 30%, particularly preferably at least 50% of the findings data collected in step b) of the maintenance cycle are quantitative findings data that can be measured on a metric scale.

Advantageously, the collection of the findings data in step b) of the maintenance cycle includes the collection of at least one feature that is selected from the group consisting of the type of maintenance measure carried out, the finding for the maintenance measure carried out, the date of the maintenance measure, flying hours accumulated between the maintenance measure and the preceding maintenance measure, flying cycles accumulated between the maintenance measure and the preceding maintenance measure, days accumulated between the maintenance measure and the preceding maintenance measure and the registration of the maintained aircraft and/or other features for the identification of the maintained aircraft.

The invention provides in step c) of the maintenance cycle the archiving of the findings data from step b) and the time interval (ΔT). Here it is advantageous if the findings data are archived in an archive that is spatially separate from the aircraft. The archive can be an electronic database.

According to a possible embodiment, the findings data can be marked on a work card during the maintenance process. Thus e.g. for qualitative findings containing certain categories, a findings field for checking can be provided on the work card for each category. Additionally, a means can be provided on the work card for the association of reference information with certain findings fields. Said means can e.g. be a barcode. The performing mechanic ticks the respective field on the work card during the maintenance process. The work card can either be read manually or by machine and the findings data read out can be stored in a database. Advantageously, the work card can be digitized by means of an optical scanner. Using stop markers the scanner recognizes that information on the work card is located at coordinates x, y, which must also be read out. This information includes the marked findings field and the associated barcode with reference information. The reference information and preferably also the digitized work card are archived in a database. An Internet connection can be used for the transfer of the data into the database.

According to an alternative embodiment, the findings data can be entered directly into a computer system during the maintenance process, so that they can be archived in an electronic database. Internet connection can be used for the transfer of the data to the database.

The invention provides that in step e) of the maintenance cycle an action request is produced for checking and/or adaptation of the maintenance interval, as long as the at least one classification number from step d) lies outside a specified tolerance range. Said action request can e.g. be directed towards the responsible systems engineer. Preferably, the specified tolerance range is defined by a maximum permitted and/or a minimum permitted number of positive findings per flying hour. Particularly preferably, the specified tolerance range is defined by a maximum permitted and/or a minimum permitted probability of a positive finding per flying hour.

It is possible that e.g. during the collection or archiving of the findings data faults occur that can adversely affect or prevent the evaluation of the finding. It is conceivable e.g. that on a work card the categories “defective” and “not defective” can either be simultaneously reported, or that no reporting takes place. It is likewise conceivable that e.g. during electronic archiving, e.g. by means of the scanning of work cards, technical faults can occur, which, if they remain undetected, could corrupt the statistical evaluation. In order to prevent any errors, it is desirable to monitor the quality of the archived findings data and where appropriate to clean up the data record.

It is therefore preferable that the findings data are subjected to a quality check and/or that a data clean-up takes place prior to the automated statistical evaluation of the findings data. Particularly preferably, an automated quality check and/or an automated data clean-up take place. The quality check and/or data clean-up can take place during the archiving (step c) or during step d) prior to the automated statistical evaluation of the findings data. The latter is preferable. If faults have been found during the quality check and/or data clean-up, it can be provided that the type and/or number of faults found can be recorded.

A maintenance cycle according to the invention enables a method to be provided for assessing and/or monitoring a maintenance program for aircraft, wherein the maintenance program is assessed and/or monitored on the basis of classification numbers obtained in at least one maintenance cycle. Within the scope of this method it can be provided that the frequency of certain findings and/or trends in the findings data are monitored.

A maintenance cycle according to the invention further enables the provision of a method for the comparison of at least two maintenance programs for aircraft, wherein classification numbers obtained in at least one maintenance cycle and/or values derived from said classification numbers are compared.

An apparatus according to the invention for the checking and/or adaptation of a maintenance interval for an aircraft comprises:
a. a device for the maintenance of aircraft;
b. a means for the collection of findings data for at least one maintenance measure to be carried out during a maintenance process for an aircraft;
c. an archive for the storage of collected findings data;
d. a means for the transfer of the collected findings data into the archive;
e. a means for the automated statistical evaluation of archived findings data, which are designed and/or established for generating an action request for the checking and/or adaptation of the maintenance interval depending on the result of the statistical evaluation;
f. a reproduction unit that is designed to reproduce the action request graphically and/or acoustically.

Advantageously, the means for the collection of findings data are designed for the recording of quantitative findings data, which can be measured on a metric scale, and/or qualitative findings data, which include certain states or categories. It is preferable that the means for the collection of findings data are selected from the group consisting of work cards, wherein the work cards preferably contain fields for checking, and computer systems, wherein the computer systems are preferably portable.

According to a possible embodiment, fields for checking or marking can be disposed on the work card, which contain certain categories, e.g. for qualitative findings. The performing mechanic then ticks the respective appropriate field on the work card during the maintenance process. In addition, a means can be provided on the work card for allocating reference information to certain findings fields. Said means can e.g. be a barcode. The work card is read out either manually or by machine.

According to an alternative embodiment, the means for the collection of findings data are computer systems. Preferably, the computer systems are portable, i.e. they can e.g. be taken by the mechanic carrying out the maintenance measure to his respective place of activity (e.g. cockpit, engines, etc.).

Preferably, the means for transferring the collected findings data to the archive comprise an optical scanner and/or an Internet connection. For example, a work card can be digitized by means of an optical scanner. Using stop markers, the scanner recognizes that there is information on the work card at the coordinates x, y, which must also be read out. This information includes the marked findings field and the corresponding barcode with reference information. The reference information and preferably also the digitized work card are transferred to an archive and stored there. An Internet connection can be used for the transfer of the data to the archive. If the means for the collection of findings data are computer systems, the data can be transferred directly to the archive via an Internet connection.

Preferably, the archive is an electronic database. Electronic databases are known in the prior art and the database can be a conventional electronic database.

It is preferable that the reproduction unit comprises a visual display unit, e.g. a commercially available computer monitor.

Faults can occur, e.g. during the collection or archiving of the findings data, which adversely affect or prevent the evaluation of the findings. It is e.g. conceivable that on a work card the categories “defective” and “not defective” can either be reported simultaneously or even that no report takes place. It is likewise conceivable that technical faults can occur, e.g. during electronic archiving, e.g. by means of scanning of work cards, which could corrupt the statistical evaluation if they remain undetected. In order to prevent possible errors, it is desirable to check the quality of the archived findings data and where appropriate to clean up the data record.

It is therefore preferable that the apparatus comprises means for a quality check of the findings data and/or a data clean-up. Advantageously, this is a means for an automated quality check of the findings data and/or an automated data clean-up. The means for a quality check of the findings data and/or a data clean-up can essentially be the same as the means for the automated statistical evaluation of archived findings data. However, it can also be a different means.

Advantageously, the means for the automated statistical evaluation of archived findings data comprise a computer system. Suitable computer systems are known to the expert. The computer system can be programmed with a statistical evaluation program,
i. so that it determines at least one classification number using an automated statistical evaluation of archived findings data for all maintenance processes occurring within a first observation period and/or using the averaged utilization factor (G) of the maintenance interval for a second observation period, wherein the first observation period and the second observation period can be the same or different and,
ii. so that it generates an action request for the checking and/or adaptation of the maintenance interval, as long as the at least one classification number lies outside a specified tolerance range.

Preferably, the averaged utilization factor (G) of the maintenance interval represents the average of all utilization factors within the second observation period.

It is particularly advantageously if the computer system comprises a data medium having data stored thereon, wherein the data represent a statistical evaluation program, wherein the statistical evaluation program is designed so that while running on the computer system
i. at least one classification number is determined using an automated statistical evaluation of archived findings data for all maintenance processes occurring within a first observation period and/or using the averaged utilization factor (G) of the maintenance interval for a second observation period, wherein the first observation period and the second observation period can be the same or different and
ii. an action request is generated for the checking and/or adaptation of the maintenance interval, as long as the at least one classification number lies outside a specified tolerance range.

The data medium can be e.g. a data medium permanently installed in the computer system, e.g. a hard disk or a flash memory. However, the data medium can also be a removable data medium. Suitable data media are known to the expert.

Preferably, the statistical evaluation program is designed so that when running on the computer system it forms at least one classification number QF1 using the averaged utilization factor (G) of the maintenance interval for the second observation period, wherein a threshold value (S) is specified, wherein QF1 is formed as follows:

for S≦G: QF1=1.0;

for G<S: QF1=G*(1.0/S);

and whereby preferably 0.5≦S≦0.95, more preferably 0.75≦S≦0.95 and particularly preferably S=0.9.

The statistical evaluation program can be designed so that when running on the computer system it forms at least one classification number using an automated statistical evaluation of archived findings data for all maintenance processes occurring within a first observation period, wherein the at least one classification number is a function of the number of positive findings for the first observation period, preferably a function of the probability of a positive finding per flying hour.

Particularly preferably, the statistical evaluation program is designed so that when running on the computer system it determines at least one classification number using an automated regression analysis of archived quantitative findings data, which can be measured on a metric scale, for all maintenance processes occurring within a first observation period.

Moreover, an object of the invention is a signal sequence representing data suitable for writing to and/or reading from a working memory and/or for sending over the Internet, wherein the data represent a statistical evaluation program for running on a computer system as part of an apparatus for the checking and/or adaptation of a maintenance interval for an aircraft, wherein the statistical evaluation program is designed so
i. that while running on the computer system it determines at least one classification number using an automated statistical evaluation of archived findings data for all maintenance processes occurring within a first observation period and/or using the averaged utilization factor (G) of the maintenance interval for a second observation period, wherein the first observation period and the second observation period can be the same or different and,
ii. that it generates an action request for the checking and/or adaptation of the maintenance interval, as long as the at least one classification number lies outside a specified tolerance range.

Preferably, the signal sequence is characterized by the fact that the statistical evaluation program is designed so that when running on the computer system it
i. forms at least one classification number QF1 using the averaged utilization factor (G) of the maintenance interval for the second observation period, wherein a threshold value (S) is specified, wherein QF1 is formed as follows

for S≦G: QF1=1.0;

for G<S: QF1=G*(1.0/S);
and wherein preferably 0.5≦S≦0.95, more preferably 0.75≦S≦0.95 and particularly preferably S=0.9;
and/or
ii. forms at least one classification number using an automated statistical evaluation of archived findings data for all maintenance processes occurring within a first observation period, wherein the at least one classification number is a function of the number of positive findings for the first observation period, preferably a function of the probability of a positive finding per flying hour.

Particularly preferably, the signal sequence is characterized by the fact that the statistical evaluation program is designed so that when running on the computer system it determines at least one classification number using an automated regression analysis of archived quantitative findings data, which can be measured on a metric scale, for all maintenance processes occurring within a first observation period.

The invention is described below using preferred embodiments by way of example with reference to the figures.

In the drawings:

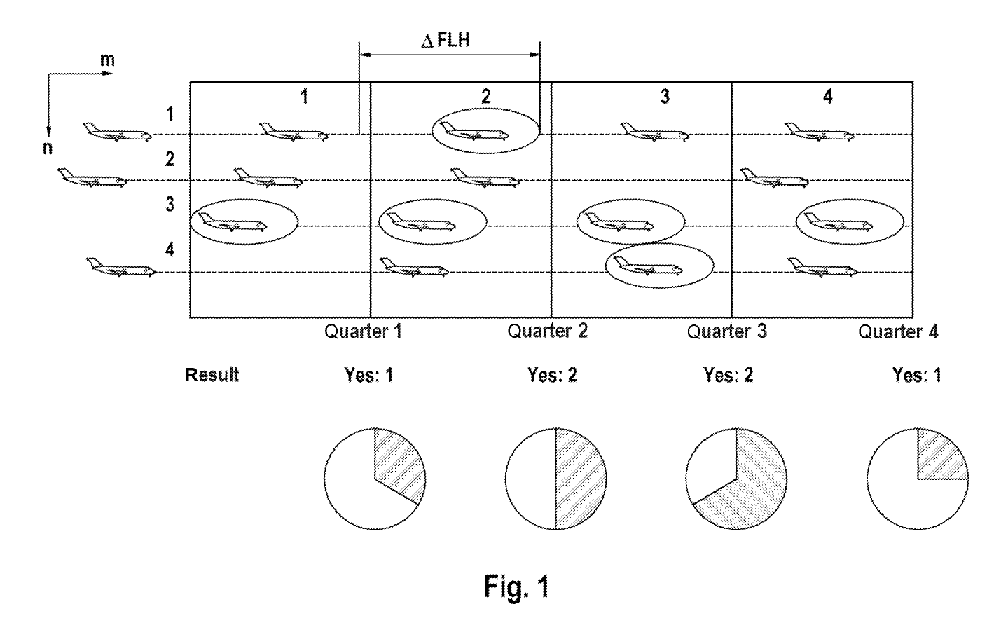

FIG. 1: shows a schematic overview of a maintenance program for a fleet of four aircraft;

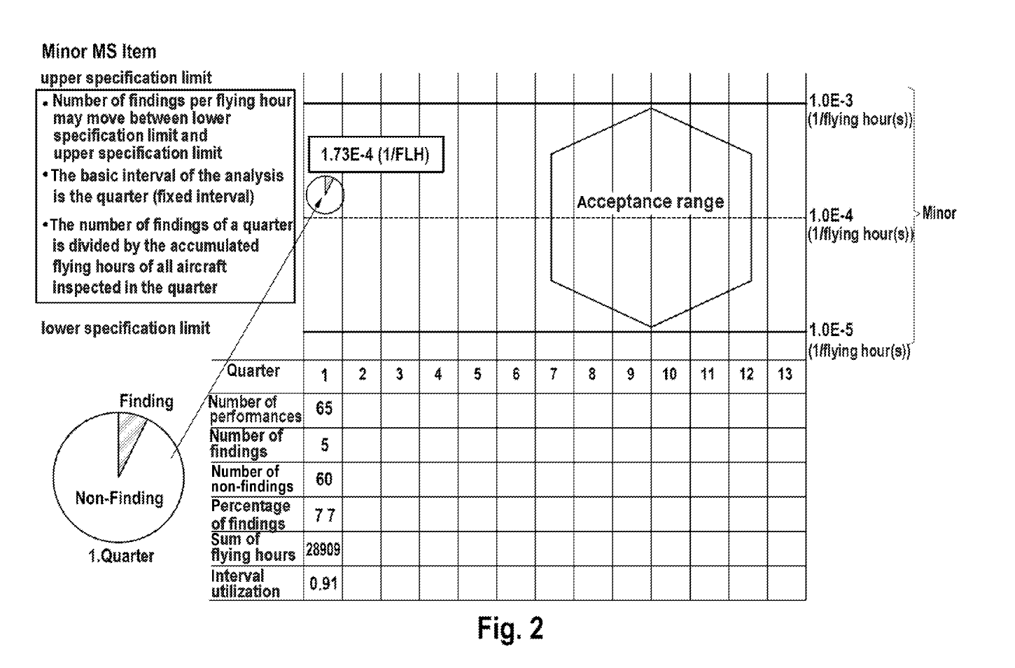

FIG. 2: shows a time series plot of the probability of error;

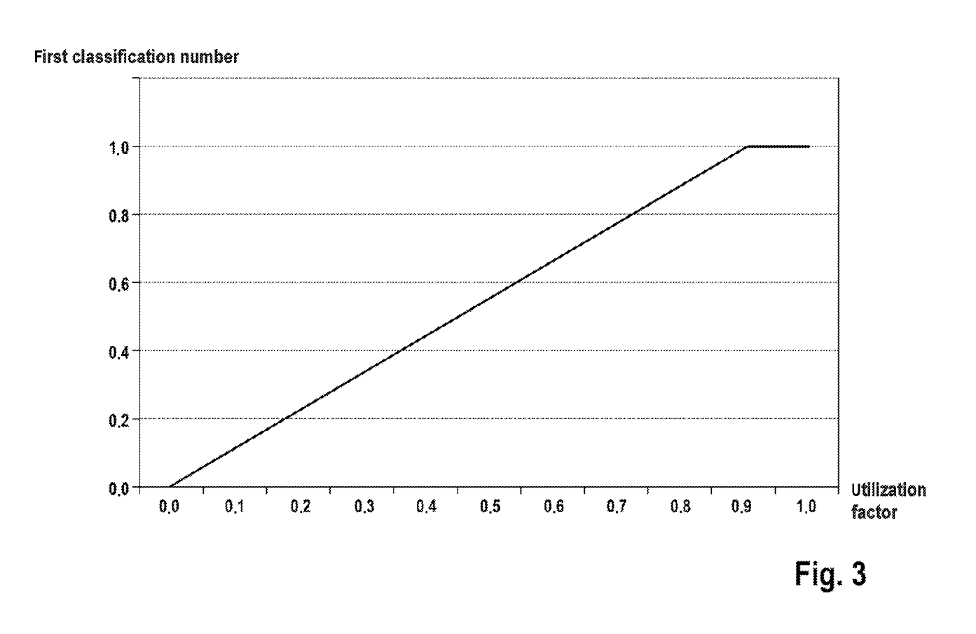

FIG. 3: shows the dependency of a determined classification number on the averaged utilization factor of the maintenance interval for a threshold value of S=0.9;

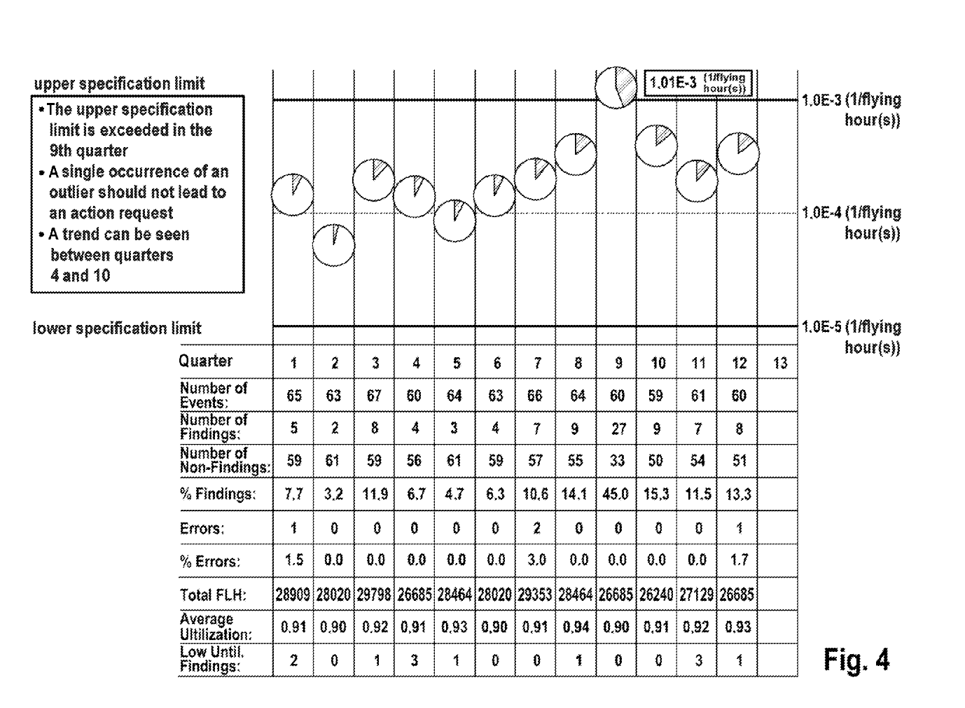

FIG. 4: shows a time series plot of the probability of error;

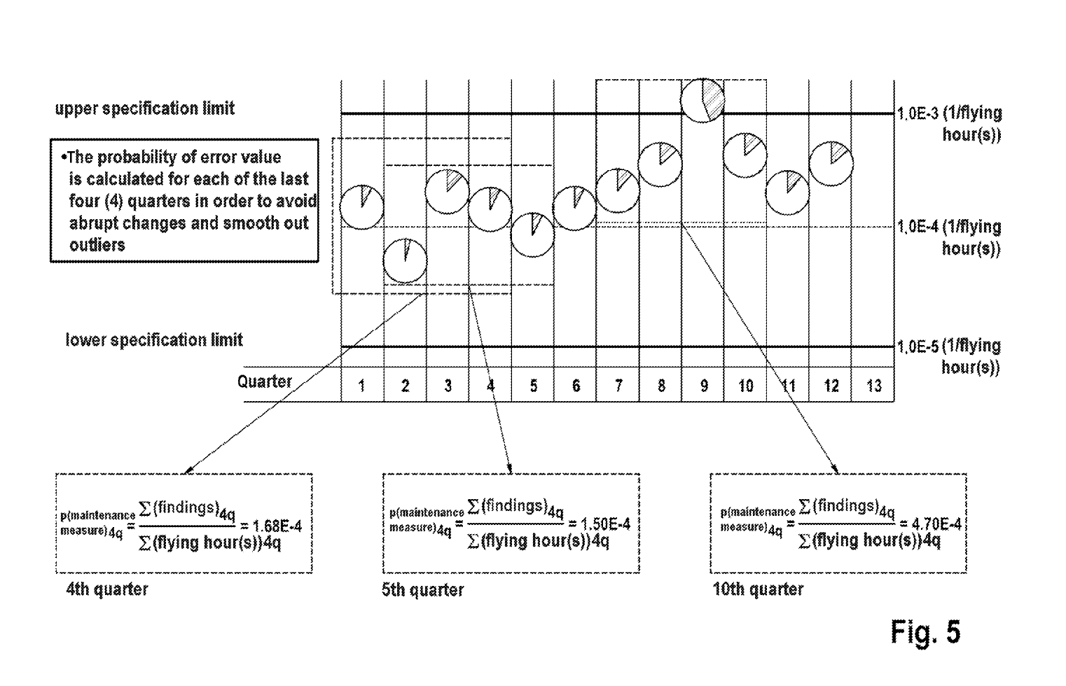

FIG. 5: shows the time series plot of the probability of error from FIG. 4 with superimposed findings for specified quarters;

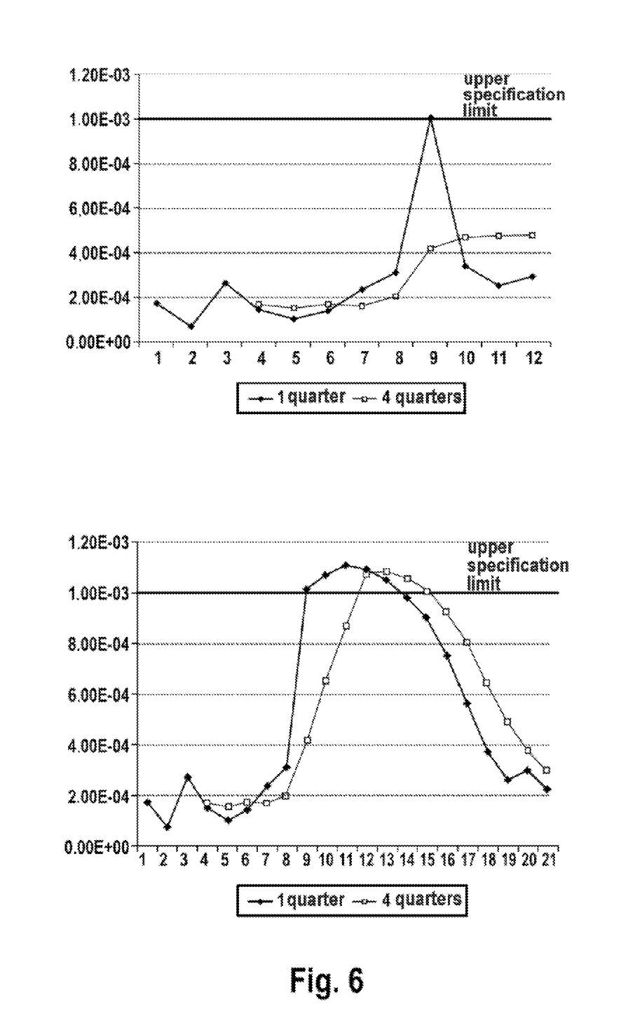

FIG. 6: shows probability of error depending on the quarter for two different examples;

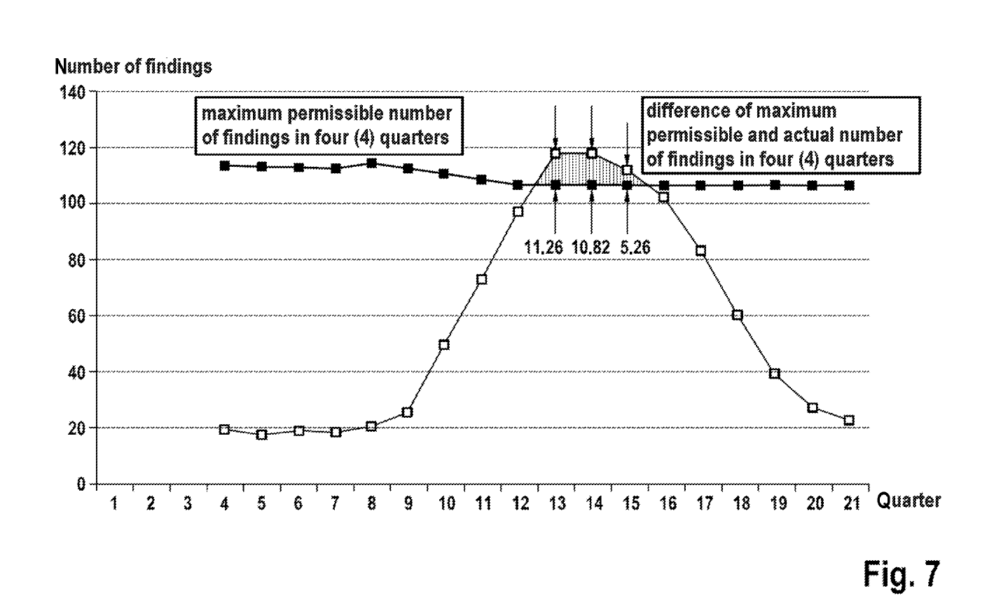

FIG. 7: shows the maximum permissible number of findings and the actual number of findings depending on the quarter;

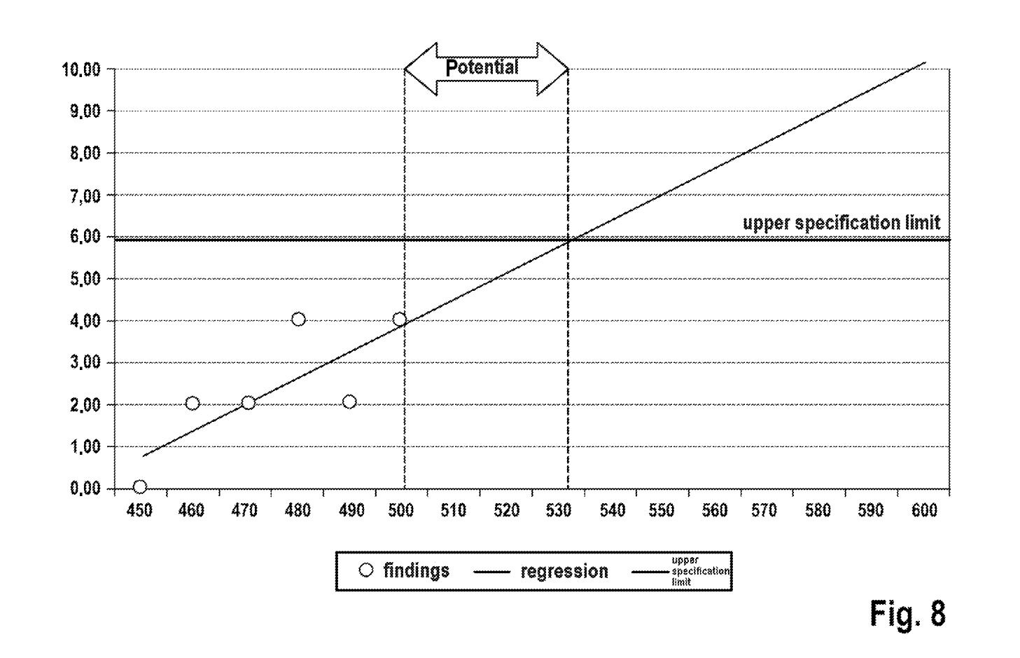

FIG. 8: shows an example of the statistical evaluation of quantitative findings data by means of linear regression;

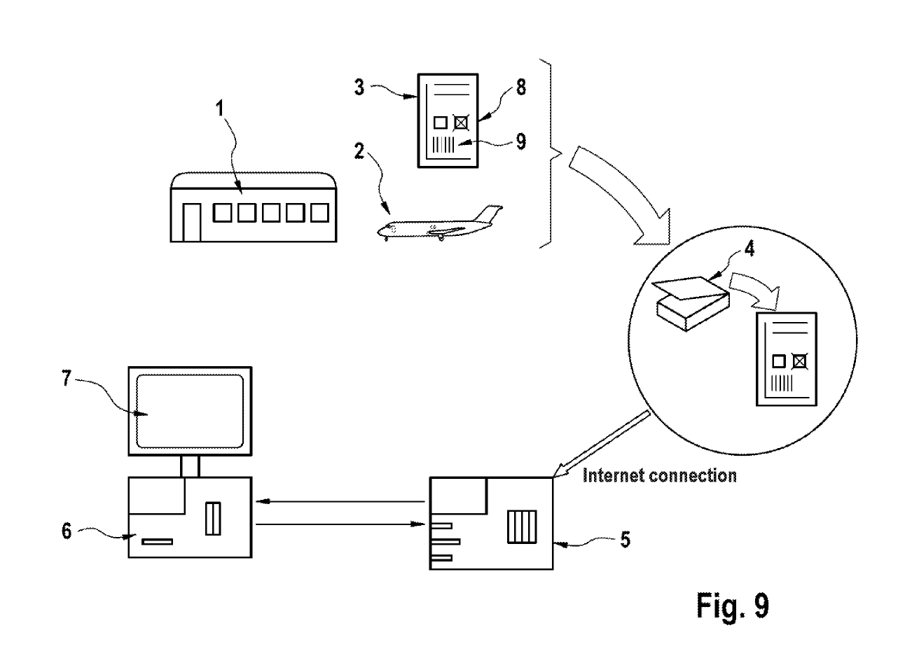

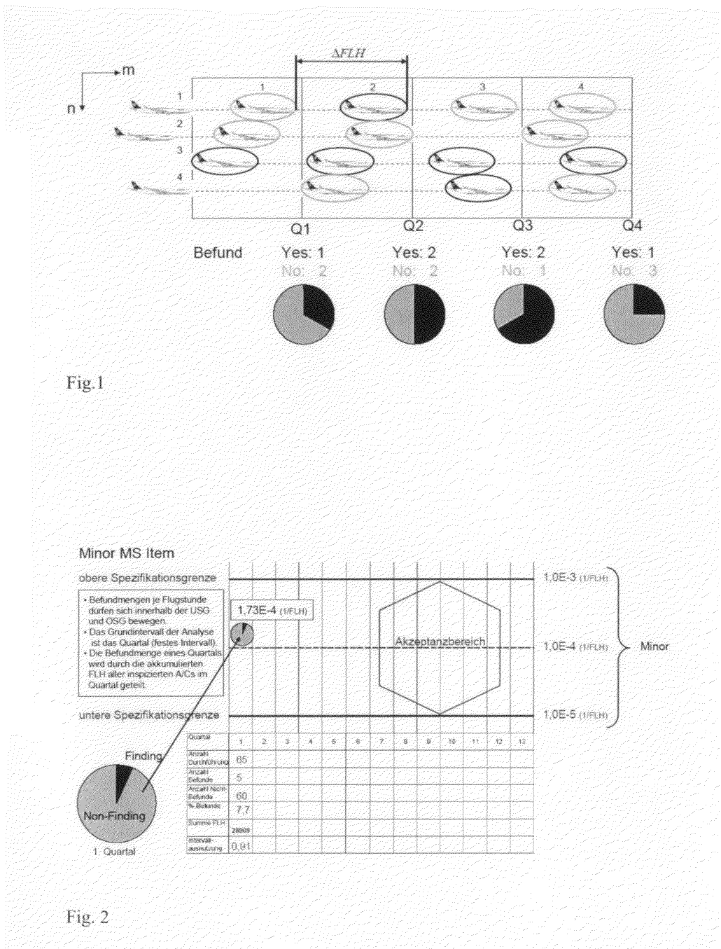

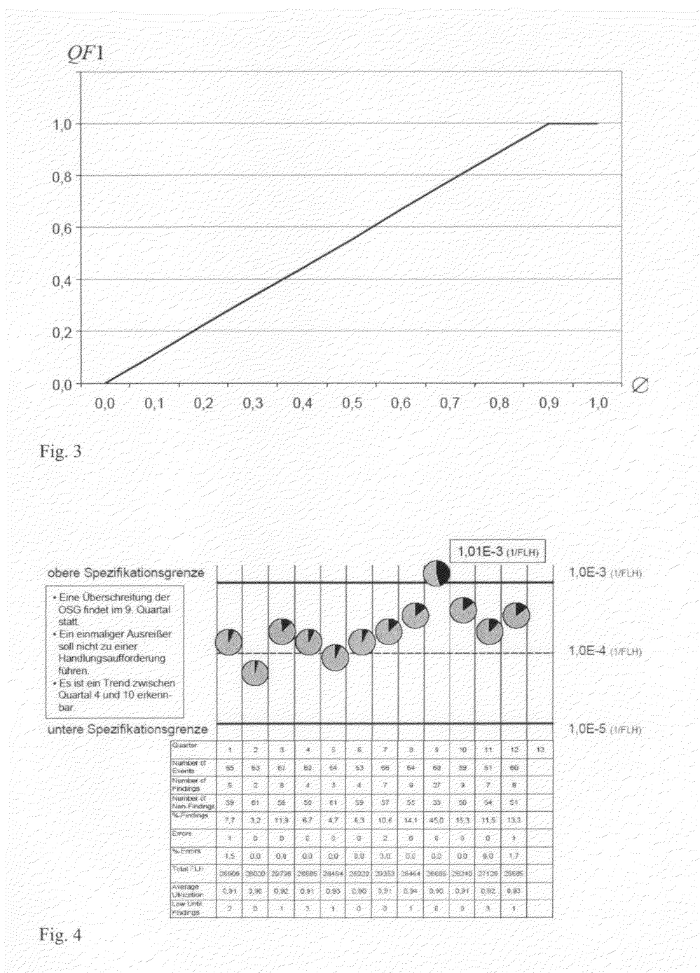

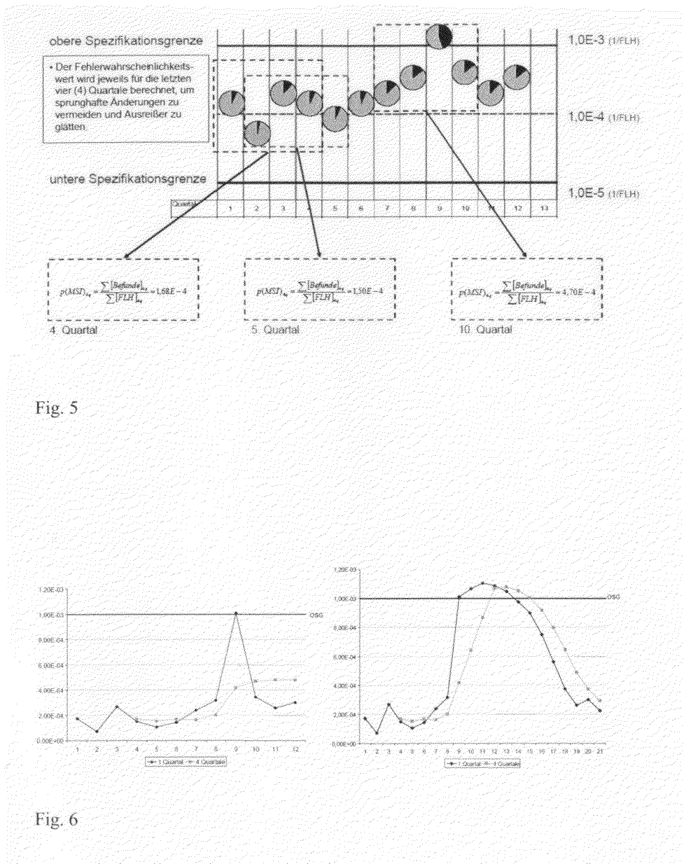

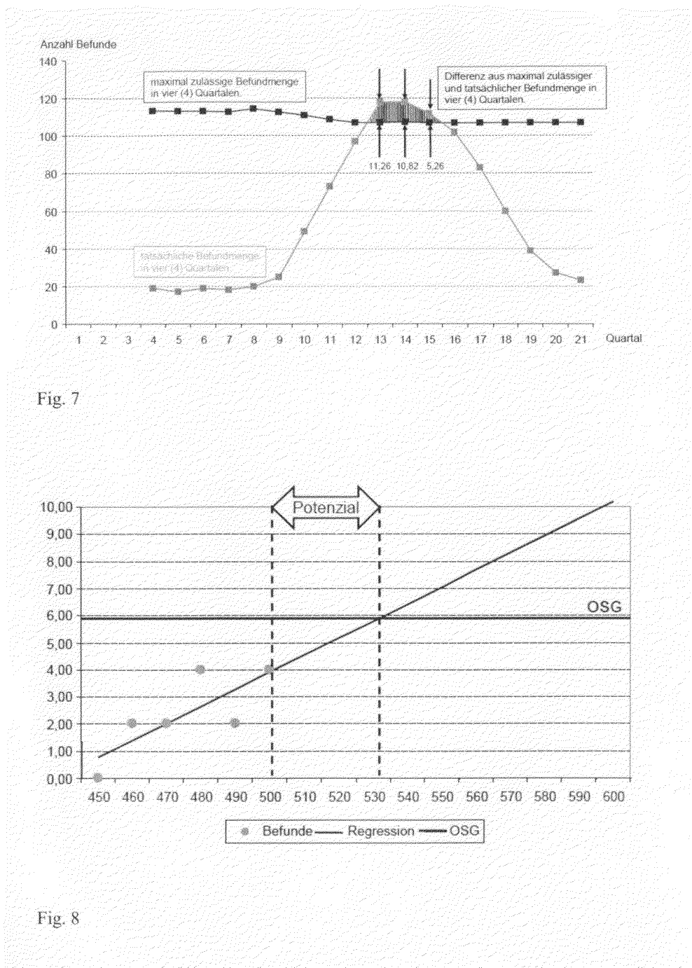

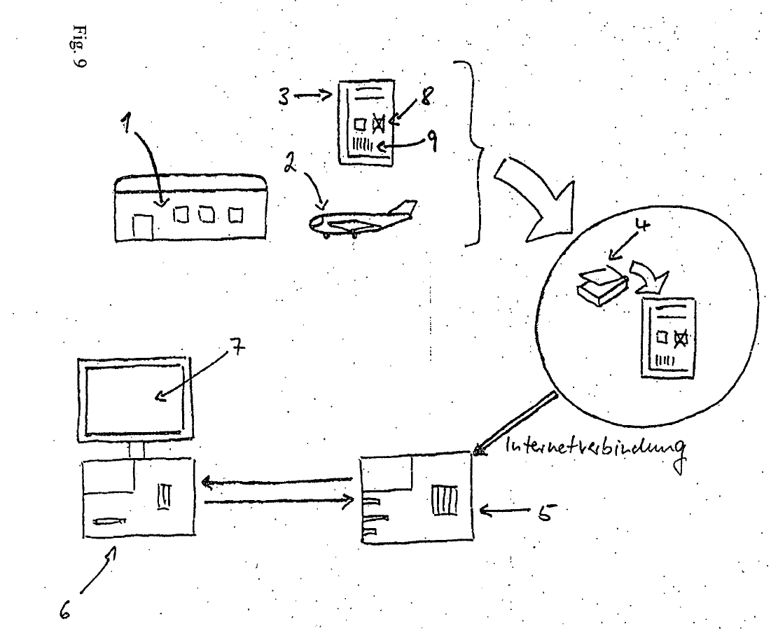

FIG. 9: shows an apparatus for the checking and/or adaptation of a maintenance interval for an aircraft.

FIG. 1 gives as an example an overview of a maintenance program for a fleet of four aircraft (n=1 through 4) over the period of time of four quarters (q=1 through 4). The maintenance processes (m) are counted for each aircraft. In this example a specified maintenance measure is carried out per maintenance process. An automated statistical evaluation of archived findings data of the respective last quarter is carried out each quarter. The number of positive findings is determined for the maintenance measure, i.e. findings that detect a fault (characterized in yellow in FIG. 1 and designated with “Yes”), and the number of negative findings for the maintenance measure, i.e. findings that do not detect a fault (marked dark blue in FIG. 1 and designated with “No”). These are reproduced in the lower region of the figure as a pie chart.

Calculation of the Accumulated Flying Hours

The accumulated flying hours during the observation period (FLH_{q}) are calculated as follows.

ΣFLH_{q}=Σ(ΔT_{m,n}),

with: ΔT_{m,n}=[FLH_{m,n}]_{q}−FLH_{(m-1),n}

wherein:

FLH represents the number of flying hours,

q represents the observation period,

n represents the respective aircraft and

m represents the respective maintenance measure.

The difference in flying hours ΔFLH between the maintenance process (m) of the aircraft (n) and the preceding maintenance process (m−1) of the aircraft (n) is calculated. The difference in flying hours ΔFLH is the actual time interval ΔT between the two maintenance processes (m) and (m−1) for the aircraft (n), i.e. the flying hours accumulated between the maintenance processes by this aircraft. This is repeated for all aircraft that come under consideration, wherein only aircraft that actually have a maintenance measure in the observation period are included in the calculation, i.e. FLH_{m,n} must lie within the observation period (q). This applies to each maintenance measure. The total number of flying hours for said observation period is obtained by summing all flying hour difference values of said observation period.

The calculation is carried out accordingly for the accumulated flying cycles or days.

FIG. 1 illustrates the calculation of the accumulated flying hours. The observation period is one quarter. For an evaluation e.g. of the second quarter (q=2), the difference in flying hours ΔFLH between the second maintenance process (m=2) of the first aircraft (n=1) and the preceding maintenance process (m=1) of the first aircraft (n=1) is calculated. This is the actual time interval ΔT between the two maintenance processes. This is repeated for all aircraft that have undergone at least one maintenance process or one maintenance measure in the second quarter. The total number of flying hours for the second quarter is obtained through summation of all flying hour difference values of said quarter.

Calculation of the Probability of Error Per Flying Hour

The positive and negative findings and where appropriate erroneous responses are counted for each observation period and maintenance measure. The sum of these values gives the total number of all performances of the maintenance measure during the observation period (q):

Σ[performances]_{q}=Σ[pos.finding]_{q}+Σ[neg.finding]_{q}+Σ[erroneous.response]_{q}

The probability of a positive finding per flying hour, i.e. the probability of error (p(maintenance measure)_{q}) for the observation period q and the maintenance measure are calculated from the respective number of positive findings determined for the maintenance measure and the sum of the flying hours during the observation period:

$${p ( maintenance . measure )}_{q} = \frac{\sum {[ pos . finding ( maintenance . measure ) ]}_{q}}{corr \cdot \sum {[ F L H ( maintenance . measure ) ]}_{q}}$$

where corr is a correction factor for the number of flying hours. The factor corr is usually 1. However, it can occur that a plurality of maintenance positions (e.g. two engine positions) can be covered by one maintenance measure. The number of flying hours can then be corrected by the factor corr and can be adapted to the number of maintenance positions covered.

FIG. 2 illustrates an example in which the calculated probability of error is related to the predefined limits of the tolerance range in a time series plot.

The example assumes that each observation period is one quarter. In this example 28909 flying hours were accumulated during the observation period (quarter 1) and 5 positive findings were counted. This gives a probability of error of 1.73E−4/FLH. The tolerance range is defined by a maximum permissible and a minimum permissible probability of positive findings per flying hour. The specified upper limit (OSG) of the tolerance range for the observed maintenance measure is 1.0E−3/FLH and the specified lower limit (USG) is 1.0E−5/FLH. The upper and lower limits define the tolerance range or the acceptance range. In the illustrated example the calculated probability of error for quarter 1 lies within the acceptance range.

Calculation of the Utilization Factor of the Maintenance Interval

The utilization factor (g_{q}) per performance (m) of a maintenance measure in the observation period (q) is calculated in flying hours as:

$${g}_{q} = \frac{Δ T}{Δ {T}_{W}} = \frac{{FLH}_{m} - {FLH}_{m - 1}}{{FLH}_{W}}$$

wherein:

ΔT is the actual time interval in flying hours (FLH) between the maintenance measure m and the preceding maintenance measure m−1 and ΔT_{W} is the specified maintenance interval in flying hours (FLH_{W}).

The calculation of the flying cycles or days is carried out in an analogous manner.

The averaged utilization factor (G_{q}) for a certain maintenance measure and an observation period (q) is calculated from the average of all previously determined utilization factors within the observation period:

$${G}_{q} = \frac{\sum {( {g}_{q} )}_{k}}{k}$$

wherein k is the total number of performances of a maintenance measure during the observation period.

The averaged utilization factor of the maintenance interval forms the basis of a first classification number (QF1).

Calculation of the First Classification Number QF1

The first classification number QF1 reflects the averaged utilization factor of the maintenance interval per maintenance measure, wherein utilization factors above a threshold value S for which there is no action request are viewed as a fulfillment. QF1 is formed depending on S as follows:

for S≦G: QF1=1.0;

for G<S: QF1=G*(1.0/S).

FIG. 3 shows the classification number QF1 as a function of the averaged utilization factor G for a threshold value S of 0.9, i.e. an at least 90% utilization of the maintenance interval.

Calculation of the Second Classification Number QF2

The classification number QF2 is a measure of being greater than or less than permissible probabilities of error. As already illustrated, the probability of error per flying hour for a maintenance measure can be illustrated as a time sequence.

FIG. 4 is an example of the time series plot from FIG. 2 over the first quarter. FIG. 4 shows a data table and the time series plot depending on the quarter for 12 quarters. In the ninth quarter the probability of a positive finding per flying hour exceeds the upper limit of the tolerance range on one occasion.

Preferably, the intervals of a maintenance program should not change abruptly but moderately. So that a single occasion of exceeding the tolerance range, as in the ninth quarter, does not already lead to an action request, in this example the probability of error values of a plurality of quarters are summarized as a rolling average. Preferably, the length of the observation period is determined depending on the maintenance interval ΔT_{W}. The longer the maintenance interval, the longer the observation period. Advantageously, the length of the observation period is determined in whole quarters as follows:

Number of quarters=ΔT_{W} (days)/90 days;

wherein this may be rounded up to the next higher number of quarters. For maintenance measures with a shorter maintenance interval than four quarters, however, the observation period is set to four quarters. As illustrated in FIG. 5, in this example the probability of error per flying hour is calculated in each case after the expiry of four quarters as follows:

$${p ( maintenance . measure )}_{4 q} = \frac{\sum {[ pos . findings ( maintenance . measure ) ]}_{4 q}}{corr \cdot \sum {[ F L H ( maintenance . measure ) ]}_{4 q}}$$

FIG. 5 shows the findings for the 4^{th}, 5^{th} and 10^{th} quarters.

This choice of observation period causes a moderate change of the probability of error value and smoothes out outliers. FIG. 6 shows the variation of the probabilities of error values respectively for the observation period of one quarter (p(maintenance measure)_{q}) and four quarters (p(maintenance measure)_{4q}). The left image in FIG. 6 illustrates the situation for an outlier under the values and the right image shows the situation of a plurality of successive incidences of exceeding the tolerance range. It can be seen that single limit violations are smoothed out by the rolling average. A plurality of limit violations lead to an increase of p(maintenance measure)_{4q} with a time delay.

It is possible to use the probability of error per flying hour directly as a classification number and for an action request to take place if p(maintenance measure)_{4q} lies outside the tolerance range. It is, however, useful to define a classification number QF2, which takes the value 1.0 if the probability of error per flying hour lies within the specified tolerance range, and, if the probability is above or below the tolerance range, it takes a value depending on the degree to which the probability is above or below the tolerance range.

The maximum permissible number of findings of the respective last four quarters per maintenance measure can be calculated as follows:

[max.finding]_{4q}=[ΣFLH]_{4q}·p(OSG)

Here p(OSG) is the probability of error per flying hour of the upper limit of the tolerance range. In the above example p(OSG) is 1.0E−3/FLH. The sum of the flying hours FLH_{4q} is the addition of the flying hours of each quarter FLH_{q} of the last four quarters.

A corresponding value is determined for the minimum desired number of desired findings:

[min.finding]_{4q}=[ΣFLH]_{4q}·p(USG)

p(USG) is the probability of error per flying hour of the lower limit of the tolerance range and lies in the upper example at 1.0E−5/FLH.

The difference of the actual number of findings in the last four quarters and the maximum permissible number of findings of the last four quarters gives the following excess number of findings in the event of exceeding the limit:

[excess]_{4q}=[␣results]_{4q}−[max.result]_{4q}.

The shortfall in the number of findings is calculated as follows:

[shortfall]_{4q}=[min.result]_{4q}−[results]_{4q}

Hence the calculation of QF2 is an OR combination of QF2_{CSG} and QF2_{USG}.

$${[ QF {2}_{OSG} ]}_{4 q} = 1 - {( \frac{{[ excess ]}_{4 q}}{{[ \sum results ]}_{4 q}} ) \\ [ QF {2}_{USG} ]}_{4 q} = 1 - ( \frac{{[ shortfall ]}_{4 q}}{{[ \sum results ]}_{4 q}} )$$

The condition for QF2 is:

[QF2_{OSG}]_{4q}<[QF2_{USG}]_{4q} [symbol] [QF2]_{4q}=[QF2_{OSG}]_{4q} [symbol] [QF2_{USG}]_{4q}<[QF2_{OSG}]_{4q} [symbol] [QF2]_{4q}=[QF2_{USG}]_{4q}

QF2 thus always takes the respective lower value of QF2_{OSG} and QF2_{USG}. If there is no limit violation, then QF2 takes the value 1.0.

FIG. 7 illustrates the calculation of QF2. The maximum permissible number of findings and the actual number of findings in four quarters are compared. Because the maximum permissible number of findings is a function of the flying hours FLH, this can vary. The first incidence of exceeding the upper limit occurs in quarter 13. The difference of the actual and the maximum permissible number of findings is 11.26 here. This means that in the last four quarters 11.26 more findings than the maximum permissible occurred or the proportion of findings above the limit is 9.5% (at a total of 118 findings in 4 quarters). QF2 is in this case 0.905, i.e. 1.0 minus 0.095. Assuming that QF1 is 1.0, a QF2 of 0.905 means that the observed maintenance measure is fulfilled to 90.5% of its intended function. 90.5% of all findings lie within the acceptable range.

It is possible to use QF2 directly as a classification number and a potential action request takes place depending on the QF2 values. Preferably, however, a classification number EI is formed from the product of [QF1]q and [QF2]4q:

EI=[QF1]_{q}·[QF2]_{4q}

In the above exemplary embodiment the first observation period for determining QF2 is 4 quarters and the second observation period for determining QF1 is 1 quarter. EI moves between 0 and 1. The limits of the tolerance range can be specified and in this exemplary embodiment have the values 1.0 and 0.9. This means that if 1.0≧EI≧0.75 no action request occurs and if 0.75>EI an action request is produced for the checking of the maintenance interval and if appropriate adaptation of the same. It can be advantageous to specify different tolerance ranges for the requests for action for checking on the one hand and adaptation of the maintenance interval on the other hand. Thus e.g. for 1.0≧EI≧0.75 there can be no request for action, for 0.9>EI≧0.75 only one action request is produced for checking of the maintenance interval and for 0.75>EI an action request for adaptation of the maintenance interval is produced. It is likewise possible to produce a warning message if the EI value is approaching the limit of the tolerance range. Thus e.g. for 1.0≧EI≧0.9 there can be no action request, for 0.9>EI≧0.75 only one warning message is produced that the EI value is approaching the limit of the tolerance range and for 0.75>EI an action request is produced for checking of the maintenance interval and if appropriate adaptation of the same.

The EI-values for the respective maintenance measures can be used to assess and/or monitor the effectiveness of a maintenance program for aircraft, or to compare two or more maintenance programs for aircraft. For this purpose e.g. the arithmetic mean MSPI of all EI values of a maintenance program can be formed:

$$MSPI = \frac{\sum EI}{N}$$

N is the number of maintenance measures with finding feedback statistics.

For assessing/monitoring of a maintenance program, the MSPI value can be compared with specified limit values. If a plurality of maintenance programs are compared with each other, said comparison can be carried out on the basis of the respective MSPI values.

Rerun Point Routine

If a maintenance measure for a finding report is provided, in the first three quarters following the rerun point it is not possible to extend the observation period to 4 quarters during the statistical evaluation of the findings data. In this case the evaluation can be carried out as described above in the exemplary embodiment, but with the measure that in the first three quarters the observation period for QF2 always includes the latest quarters between the quarter in question and the rerun point. That means that following the first quarter QF2 is determined for an observation period of one quarter, following two quarters QF2 is determined for an observation period of two quarters and following three quarters QF2 is determined for an observation period of three quarters. From the fourth quarter the evaluation then takes place as described above. For other embodiments of the invention for which the observation period is longer than 4 quarters, the rerun point routine can be used in an analogous manner.

Regression Analysis

The feedback of quantifiable findings data opens up the possibility of identifying the validity of two variables, e.g. by means of regression analysis.

In the simplest case of a relationship this is linear. The determination of a straight line that represents the relationship between random variable is referred to as linear regression. Using linear regression, e.g. using the findings data of a quarter, the number of flying hours, flying cycles or days can be calculated at which the upper limit of the tolerance range will be reached. The difference of said calculated value and the actual maintenance interval is an indicator of the escalation potential of the maintenance interval.

The method of linear regression is known to the expert. The corresponding calculations are explained below using an example for one quarter.

The gradient of the straight line of the approximate equation is calculated as

y=b₀+b₁·x

The parameters b₀ (y axis section) and b₁ (gradient) can be viewed as classification numbers, which should lie within a certain tolerance range. If this is not the case, an action request for checking or adaptation of the maintenance interval is produced. The parameters b0 and b1 are calculated as follows:

$${b}_{1} ≡ \frac{{\sum }_{i = 1}^{n} {x}_{i} {y}_{i} - n \overline{xy}}{{\sum }_{i = 1}^{n} {x}_{i}^{2} - n {\overline{x}}^{2}}$$

$$and$$

$${b}_{0} ≡ \overline{y} - {b}_{1} \cdot \overline{x}$$

Here x̅ and y̅ stand for the respective arithmetic means of the random variables.

If the linear equation is solved for x (FLH) and the value of the upper limit for the tolerance range (OSG) is set for y, then the maximum maintenance interval can be calculated and the escalation potential can be determined from the difference from the current maintenance interval. This is illustrated in FIG. 8.

FIG. 9 shows an apparatus for checking and/or adaptation of a maintenance interval for an aircraft. The apparatus comprises a device (1) in the form of a maintenance hangar for maintenance of aircraft (2) and a means in the form of work cards (3) for collection of findings data for at least one maintenance measure to be carried out during a maintenance process for an aircraft. The work card (3) comprises findings fields for checking (8), which include defined categories for qualitative findings. Furthermore, the work card comprises means in the form of a barcode (9) for associating reference information with the findings fields. The apparatus also comprises an optical scanner (4) for digitizing and for reading the work cards and an Internet connection for transferring the read out data and the digitized work cards into the database (5). A computer system (6) is used for automated statistical evaluation of archived findings data. The computer system (6) is programmed with a statistical evaluation program so
i. that it determines at least one classification number using automated statistical evaluation of archived findings data for all maintenance processes occurring within a first observation period and/or using the averaged utilization factor (G) of the maintenance interval for a second observation period, wherein the first observation period and the second observation period can be the same or different and,
ii. that it generates an action request for checking and/or adaptation of the maintenance interval if the at least one classification number lies outside a specified tolerance range.

A visual display unit (7) is used to graphically reproduce the action request.

1. A maintenance cycle for an aircraft comprising the following steps:
a) carrying out a maintenance process for an aircraft after the expiry of a time interval (ΔT) that is less than or equal to a specified maintenance interval (ΔT_{W});
b) collecting findings data for at least one maintenance measure during the maintenance process;
c) archiving the findings data from step b) and of the time interval ΔT;
d) determining at least one classification number using an automated statistical evaluation of archived findings data for all maintenance processes occurring within a first observation period and/or using an averaged utilization factor (G) of the maintenance interval for a second observation period, wherein the first observation period and the second observation period can be the same or different;
e) producing an action request for checking and/or adaptation of the maintenance interval if the at least one classification number from step d) lies outside a specified tolerance range.

2. The maintenance cycle of claim 1, wherein the findings data in step d) originate from more than one aircraft.

3. The maintenance cycle of claim 1, wherein the averaged utilization factor (G) of the maintenance interval is calculated from the average of all utilization factors within the second observation period.

4. The maintenance cycle of claim 1, wherein the utilization factor of the maintenance interval is a function of the quotient of the time interval and the maintenance interval (ΔT/ΔT_{W}).

5. The maintenance cycle of claim 1, wherein in step d) at least one classification number QF1 is formed using the averaged utilization factor (G) of the maintenance interval for the second observation period, wherein a threshold value (S) is specified, wherein QF1 is formed as follows:
for S≦G: QF1=1.0;
for G<S: QF1=G*(1.0/S).

6-17. (canceled)

18. The maintenance cycle of claim 5, wherein 0.5≦S≦0.95.

19. The maintenance cycle of claim 5, wherein 0.75≦S≦0.95.

20. The maintenance cycle of claim 5, wherein S=0.9.

21. The maintenance cycle of claim 1, wherein the time interval (ΔT) and/or the maintenance interval (ΔT_{W}) is calculated in days.

22. The maintenance cycle of claim 1, wherein the time interval (ΔT) and/or the maintenance interval (ΔT_{W}) is calculated in flying cycles.

23. The maintenance cycle of claim 1, wherein the time interval (ΔT) and/or the maintenance interval (ΔT_{W}) is calculated in flying hours.

24. The maintenance cycle of claim 1, wherein the length of the first observation period and/or the length of the second observation period can be represented in whole quarters and/or wherein the length of the first observation period and/or the length of the second observation period is determined depending on the maintenance interval (ΔT_{W}).

25. The maintenance cycle of claim 24, wherein the length of the first observation period and/or of the second observation period is at least one quarter.

26. The maintenance cycle of claim 24, wherein the length of the first observation period and/or of the second observation period is at least four quarters.

27. The maintenance cycle of claim 24, wherein the length of the first observation period and/or of the second observation period is at least eight quarters.

28. The maintenance cycle of claim 24, wherein the first observation period is longer than the second observation period.

29. The maintenance cycle of claim 24, wherein the length of the first observation period is four quarters and the length of the second observation period is one quarter.

30. The maintenance cycle of claim 24, wherein the length of the first observation period and/or the length of the second observation period is determined in whole quarters as follows:
Number of quarters=ΔT_{W} (days)/90 days;
wherein, if appropriate, the number of quarters is rounded up to the next higher number of whole quarters.

31. The maintenance cycle of claim 30, wherein the number of quarters is at least 4.

32. The maintenance cycle of claim 1, wherein in step d) at least one classification number is determined using automated statistical evaluation of archived findings data for all maintenance processes occurring within a first observation period, wherein the at least one classification number is a function of the number of positive findings for the first observation period.

33. The maintenance cycle of claim 32, wherein the at least one classification number is a function of the probability of a positive finding per flying hour.

34. The maintenance cycle of claim 1, wherein
i) the findings data are archived in an archive spatially separated from the aircraft and/or,
ii) prior to the automated statistical evaluation of the findings data, the findings data are subjected to a quality check and/or that a data clean-up takes place and/or,
iii) the specified tolerance range is defined by a maximum permissible number and/or a minimum permissible number of positive findings per flying hour, preferably by a maximum permissible probability and/or a minimum permissible probability of a positive finding per flying hour.

35. The maintenance cycle of claim 1, wherein the specified tolerance range is defined by a maximum permissible probability and/or a minimum permissible probability of a positive finding per flying hour.

36. The maintenance cycle of claim 1, wherein in step d) at least one classification number is determined using an automated regression analysis of archived quantitative findings data, which can be measured on a metric scale, for all maintenance processes occurring within a first observation period.

37. The maintenance cycle of claim 1, wherein at least 5% of the findings data collected in step b) are quantitative findings data measurable on a metric scale.

38. The maintenance cycle of claim 1, wherein at least 30% of the findings data collected in step b) are quantitative findings data measurable on a metric scale.

39. The maintenance cycle of claim 1, wherein at least 50% of the findings data collected in step b) are quantitative findings data measurable on a metric scale.

40. The maintenance cycle of claim 1, wherein the collection of the findings data includes the collection of at least one feature, which is selected from the group consisting of the type of the maintenance measure carried out, the finding for the maintenance measure carried out, the date of the maintenance measure, cumulative flying hours between the maintenance measure and the preceding maintenance measure, cumulative flying cycles between the maintenance measure and the preceding maintenance measure, cumulative days between the maintenance measure and the preceding maintenance measure and the registration of the maintained aircraft and/or other features for the identification of the maintained aircraft.

41. A method for assessing and/or monitoring of a maintenance program for aircraft, wherein the maintenance program is assessed and/or monitored on the basis of classification numbers, wherein said classification numbers are obtained in at least one maintenance cycle according to claim 1.

42. A method for the comparison of at least two maintenance programs for aircraft, wherein in at least one maintenance cycle classification numbers obtained and/or values derived from said classification number are compared according to claim 1.
